(19) United States
(12) Patent Application Publication
(10) Pub. No.: US 2015/0269189 A1
(43) Pub. Date: Sep. 24, 2015

(54) RETRIEVAL APPARATUS, RETRIEVAL METHOD, AND COMPUTER PROGRAM PRODUCT

(71) Applicant: KABUSHIKI KAISHA TOSHIBA, Tokyo (JP)

(72) Inventors: Yusuke TAZOE, Kokubunji Tokyo (JP); Masashi NISHIYAMA, Kawasaki Kanagawa (JP)

(73) Assignee: KABUSHIKI KAISHA TOSHIBA, Tokyo (JP)

(21) Appl. No.: 14/656,418

(22) Filed: Mar. 12, 2015

(30) Foreign Application Priority Data
Mar. 19, 2014 (JP) 2014-056920

(51) Int. Cl. G06F 17/30; G06T 3/40; G06K 9/62; G06K 9/46; G06T 7/00

(52) U.S. Cl. CPC G06F 17/30247; G06K 9/4604; G06T 7/0081; G06K 9/6215; G06T 3/40; G06T 2210/16

(57) ABSTRACT

According to an embodiment, a retrieval apparatus includes a first receiving device, an obtaining device, a calculator, a determining controller, and a first display controller. The first receiving device receives selection of at least one mask image from among a plurality of predetermined mask images indicating retrieval target areas. The obtaining device obtains a first image. The calculator calculates a first feature quantity of an extraction area defined by the mask image in the first image. The determining controller searches for second information, in which a second image and a second feature quantity of each of a plurality of items are associated with each other, and determines the second image corresponding to the second feature quantity having a degree of similarity with the first feature quantity equal to or greater than a threshold value. The first display controller performs control to display the determined second image on a display.

### CROSS-REFERENCE TO RELATED APPLICATIONS

This application is based upon and claims the benefit of priority from Japanese Patent Application No. 2014-056920, filed on Mar. 19, 2014; the entire contents of which are incorporated herein by reference.

### FIELD

Embodiments described herein relate generally to a retrieval apparatus, a retrieval method, and a computer program product.

### BACKGROUND

A technology has been disclosed in which an image is used as a search key, and a user-desired item is retrieved from among various items of apparel or various items of components. For example, a technology has been disclosed in which an entire image is used as a search key, and a similar image that is similar to that entire image is retrieved from the search destination. Moreover, a technology has been disclosed in which, from an image including a plurality of products, the area other than the targeted product is deleted so as to extract the retrieval target area; and the extracted area is used as a search key so as to retrieve relevant products.

However, conventionally, when at least a portion of the retrieval target item in an image is positioned on the back of some other article, it is a difficult task to accurately retrieve the items related to the retrieval target item which is of interest to the user.

### BRIEF DESCRIPTION OF THE DRAWINGS

FIG. 1 is a block diagram of a retrieval apparatus;

FIG. 2 is a diagram illustrating an exemplary data structure of second information;

FIG. 3 is a diagram illustrating exemplary data structure of first information;

FIG. 4 is a diagram illustrating an exemplary data structure of first information;

FIG. 5 is a diagram illustrating an exemplary data structure of first information;

FIG. 6 is a diagram illustrating an exemplary data structure of first information;

FIG. 7 is a diagram illustrating examples of mask images;

FIG. 8 is a diagram illustrating examples of mask images;

FIG. 9 is a diagram illustrating an exemplary data structure of the first information;

FIG. 10 is a diagram illustrating an exemplary data structure of the first information;

FIG. 11 is a schematic diagram illustrating exemplary images displayed on a display;

FIG. 12 is an explanatory diagram illustrating modification of a mask image;

FIG. 13 is an explanatory diagram illustrating modification of a mask image;

FIG. 14 is a flowchart for explaining a sequence of operations during a retrieval operation;

FIG. 15 is an explanatory diagram of a conventional retrieval apparatus;

FIG. 16 is an explanatory diagram about defining the retrieval target area in a retrieval apparatus;

FIG. 17 is a schematic diagram illustrating a retrieval system; and

FIG. 18 is a block diagram illustrating an exemplary hardware configuration of the retrieval apparatus.

### DETAILED DESCRIPTION

According to an embodiment, a retrieval apparatus includes a first receiving device, an obtaining device, a calculator, a determining controller, and a first display controller. The first receiving device receives selection of at least one mask image from among a plurality of predetermined mask images indicating retrieval target areas. The obtaining device obtains a first image. The calculator calculates a first feature quantity of an extraction area defined by the selected mask image in the first image. The determining controller searches for second information, in which a second image and a second feature quantity of each of a plurality of items are associated with each other, and determines the second image corresponding to the second feature quantity having a degree of similarity with the first feature quantity equal to or greater than a threshold value. The first display controller performs control to display the determined second image on a display.

Embodiments will be explained below in detail with reference to the accompanying drawings.

### First Embodiment

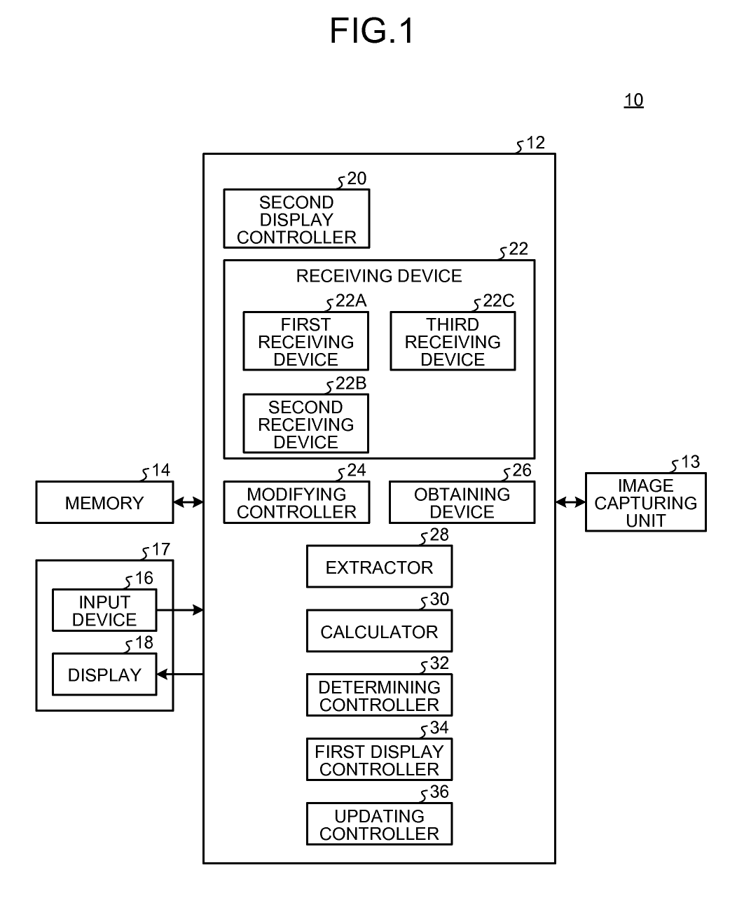

FIG. 1 is a block diagram illustrating a functional configuration of a retrieval apparatus 10 according to a first embodiment. The retrieval apparatus 10 includes a controller 12, an image capturing unit 13, a memory 14, an input device 16, and a display 18. The controller 12 is connected to the image capturing unit 13, the memory 14, the input device 16, and the display 18 in a manner which allows transfer of signals therebetween.

In the first embodiment, the explanation is given for an example in which the retrieval apparatus 10 is a handheld device that includes the controller 12, the image capturing unit 13, the memory 14, the input device 16, and the display 18 in an integrated manner. Examples of the handheld device include a smartphone or a tablet personal computer (PC). However, the retrieval apparatus 10 is not limited to a handheld device. Alternatively, for example, the configuration of the retrieval apparatus 10 can be such that at least one of the image capturing unit 13, the memory 14, the input device 16, and the display 18 is separated from the controller 12. In this case, for example, the retrieval apparatus 10 can be a PC including the image capturing unit 13.

Given below is the detailed explanation of the retrieval apparatus 10.

The image capturing unit 13 obtains a first image by performing image capturing.

A first image is an image including a retrieval target item. Herein, the item is a target to be retrieved by the retrieval apparatus 10. An item may be an article for sale or a non-commodity that is not for sale. As long as an item can be captured in an image, it serves the purpose. Examples of items include items related to clothing, items related to household furniture, items related to travel, items related to home electrical appliances, and items related to components. However, these are not the only possible examples.

The items related to clothing include objects used in clothing, such as furnishings or beauty-related objects, or hairstyles, which are visually recognizable in nature. Herein, furnishings include apparel and ornaments. The apparel is articles that can be worn by a photographic subject. Examples of apparel include outerwear, skirts, pants, shoes, and hats. Examples of ornaments include artifacts such as rings, necklaces, pendants, and earrings that can be adorned. The beauty-related objects include hairstyles or cosmetic items to be applied to the skin or the like.

The items related to travel include images that enable geographical identification of the travel destination, images that enable topographical identification of the travel destination, and images indicating the buildings built at the travel destination or indicating the suitable seasons to travel to the travel destination.

A first image is, for example, a captured image of a photographic subject wearing items, a captured image of an outdoor landscape including items, a captured image of indoors including items, a captured image of a magazine having items published therein, or a captured image of an image displayed on a display device.

Meanwhile, the photographic subject is not limited to a human being, and can alternatively be a living organism, an article other than living organisms, or a picture representing the shape of a living organism or an article. Examples of a living organism include a person, a dog, and a cat. Examples of an article include a mannequin representing the shape of a human being or an animal, and a picture representing the shape of the human body or an animal. Moreover, examples of the display device include a liquid crystal display (LCD), a cathode ray tube (CRT), and a plasma display panel (PDP) that are known devices.

In the first embodiment, the explanation is given for a case in which a first image includes items related to clothing as the retrieval target items.

The image capturing unit 13 is a digital camera or a digital video camera of a known type. The image capturing unit 13 obtains a first image by means of image capturing, and outputs the first image to the controller 12.

The memory 14 is a memory medium such as a hard disk drive (HDD) or an internal memory; and is used to store second information and first information.

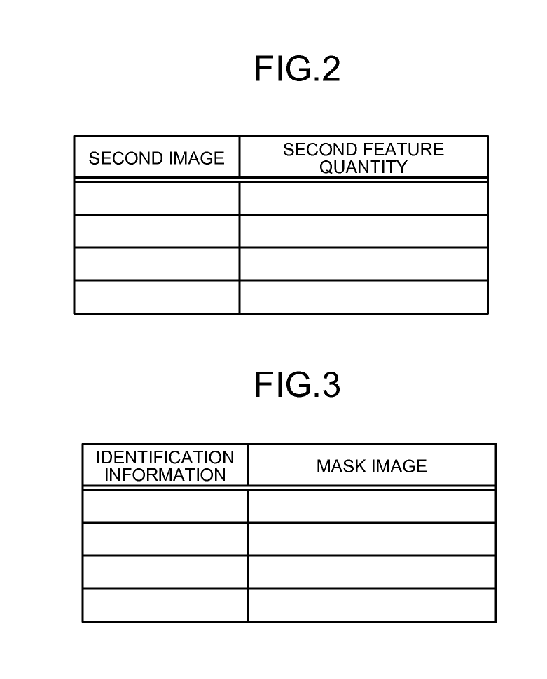

FIG. 2 is a diagram illustrating an exemplary data structure of the second information. In the second information, second images and second feature quantities of a plurality of items are associated with each other. Herein, the second information can be maintained in the form of a database. However, that is not the only possible case.

A second image represents an item image. A second image represents an image of one item. For example, second images are images of items such as a variety of apparel or various articles.

In the first embodiment, the explanation is given for a case in which a second image represents an image of an item related to clothing. Thus, in the first embodiment, a second image represents an image of each of items such as a coat, a skirt, and outerwear.

A second feature quantity represents a numerical value indicating the feature of a second image. A second feature quantity is a numerical value obtained by analyzing the corresponding second image. More particularly, the controller 12 calculates the second feature quantity for each second image stored in the memory 14. Then, the controller 12 registers each second feature quantity so as to be associated with the corresponding second image. With that, the controller 12 stores the second information in advance in the memory 14.

The controller 12 calculates, as the second feature quantity of a second image, a value obtained by, for example, quantifying the contour shape of the item represented by the second image. That is, the controller 12 calculates, as a second feature quantity, the HoG feature quantity of the corresponding second image, or the SIFT feature quantity of the corresponding second image, or a combination of the HoG feature quantity and the SIFT feature quantity. Meanwhile, the color feature (i.e., pixel values of R, G, and B) of the second image can also be added to the second feature quantity.

FIG. 3 is a diagram illustrating an exemplary data structure of the first information. In the first information, identification information and mask information are associated with each other. Although the first information can be maintained in the form of a database, that is not the only possible case.

The first information has a plurality of mask images registered therein in advance. Moreover, the mask images have at least mutually different shapes or mutually different sizes. A mask image enables identification of the retrieval target area. More particularly, a mask enables identification of the shape and the size of the retrieval target area. A mask image is formed as, for example, a linear image.

Moreover, each mask image corresponds to one of a plurality of categories formed by classifying a plurality of items according to a predetermined classification condition. Regarding the classification condition, it is possible to set an arbitrary condition. For example, the classification condition can be the item color, the item type, or the item manufacturer. The item type can be the shape of the item, the body part on which the item is to be worn, and the material of the item. Examples of the item type include the top, the coat, the shirt, the bottom, the skirt, the small article, and the watch. Examples of the item shape include the collar shape, the sleeve length, the sleeve width, and the hemline length.

In the first embodiment, a mask image is a linear image formed along with at least a portion of the common contour of the items belonging to each of a plurality of categories. For example, consider a case in which an item represents European clothing, and the category is short-sleeved V-neck T-shirt. In that case, the mask image is a linear image formed along the common contour shape of one or more T-shirt items belonging to the category (T-shirt, short-sleeved, and V-neck).

Meanwhile, as long as the shape of a mask image reflects the feature of the contour shape of an item belonging to a category, it serves the purpose. Thus, the shape of a mask image is not limited to the shape along the contour shape.

The identification information enables identification of the categories. Moreover, the identification information is made of one or more pieces of identification information each of which represents a classification condition of the categories.

Thus, in the first information, to each category identified by the identification information, a mask image is associated in advance. In the first embodiment, a mask image is equivalent to a linear image that represents the contour shape, which is quantified by the second feature quantity, of the item belonging to the category which is identified by the corresponding identification information.

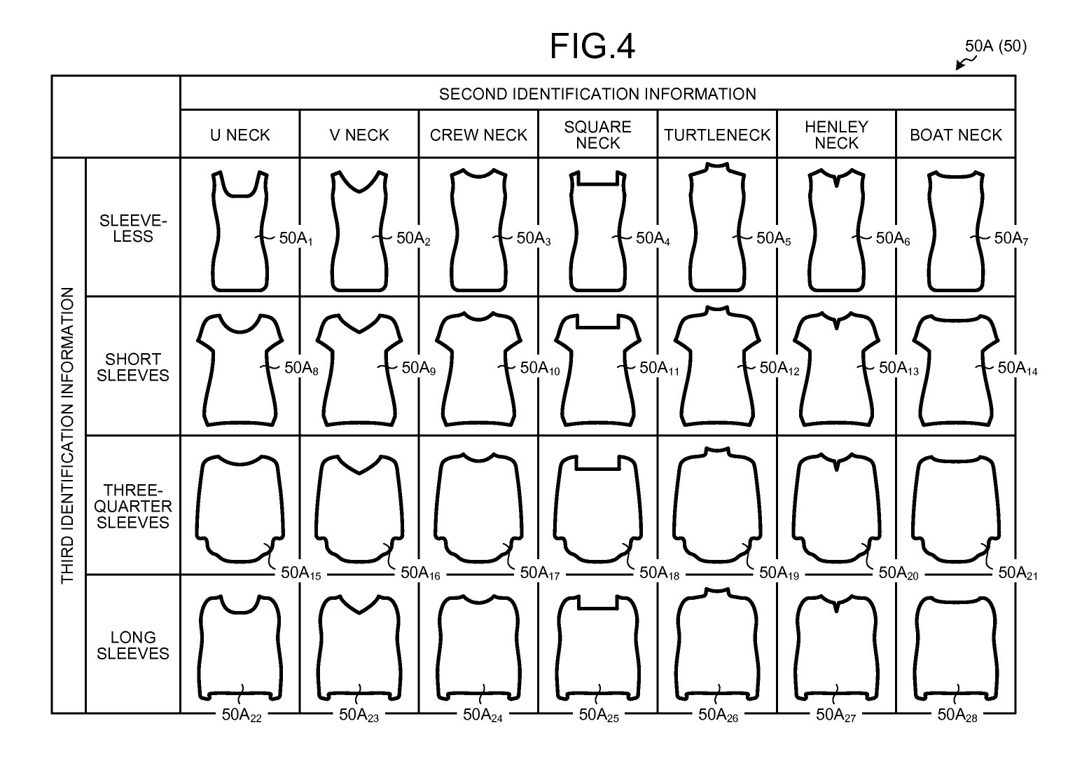

FIG. 4 is a diagram illustrating in detail an exemplary data structure of the first information. In FIG. 4, mask images 50A representing T-shirt contour shapes are illustrated as mask images 50 included in the first information.

In the example illustrated in FIG. 4, in the first information, the identification information contains first identification information, second identification information, and third identification information. In the example illustrated in FIG. 4, the first identification information is “T-shirt” (not illustrated). Moreover, the second identification information indicates the collar shapes of T-shirts. Furthermore, the third identification information indicates the sleeve lengths of T-shirts. However, the identification information is not limited to this example.

In the example illustrated in FIG. 4, in the first information, each of mask images 50A₁ to 50A₂₃ is associated to one category identified by the first identification information, the second identification information, and the third identification information.

In the first embodiment, in the case of referring to the mask images without distinction, the collective term “mask images 50” is used. However, in the case of referring to variation examples of the mask images, alphanumeric characters are assigned subsequent to the reference numeral “50”.

Meanwhile, the first information can be information in which the mask images 50 are associated to only some of the categories identified by the identification information.

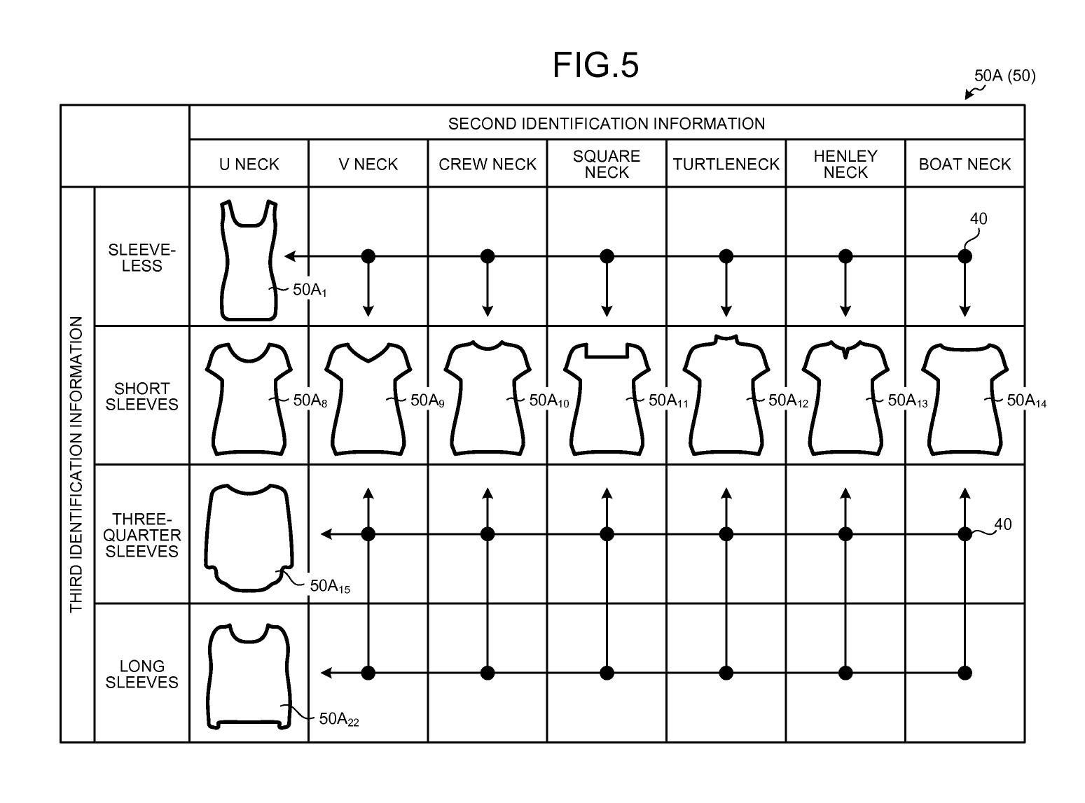

FIG. 5 is a diagram illustrating in detail an exemplary data structure of the first information. As illustrated in FIG. 5, in the first information, for each piece of first identification information, a database structure is maintained in which pieces of second identification information are arranged in columns and pieces of third identification information are arranged in rows. Then, for the categories identified by one of the pieces of second identification information and each piece of third identification information, the corresponding mask images 50 (with reference to FIG. 5, the mask image 50A₁, the mask image 50A₈, the mask image 50A₁₅, and the mask image 50A₂₂) are set in advance. Similarly, for the categories identified by each piece of second identification information and one of the pieces of third identification information, the corresponding mask images 50 (with reference to FIG. 5, the mask images 50A₈ to 50A₁₄) are set in advance.

In this way, the first information can be information in which the mask images 50 are associated to only some of the categories that are identified by the identification information.

In this case, if the mask images 50 corresponding to any categories identified by the identification information are not registered in the first information (in FIG. 5, see a reference numeral “40”), then the controller 12 (described later) creates the mask images 50 in the following manner. For example, in the database illustrated in FIG. 5, regarding the categories which are identified by the identification information but for which the mask images 50 are not registered, the controller 12 creates the mask images 50 for such categories using the mask images 50 registered in the neighboring positions in the row direction and using the mask images 50 registered in the neighboring positions in the column direction (in FIG. 5, see the reference numeral “40”). Then, using the mask images 50 that are created, the controller 12 can perform the operations described later.

In this way, when the data structure of the first information is such that the mask images 50 are associated to only some of the categories, it becomes possible to prevent an increase in the volume of data of the first information.

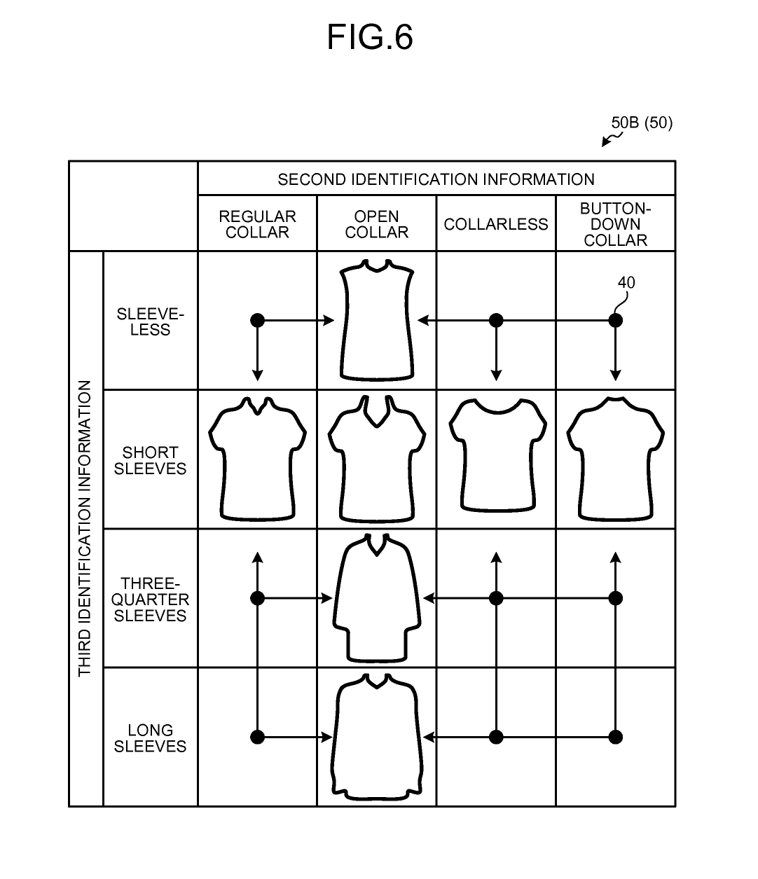

Meanwhile, the categories identified by the identification information are not limited to “T-shirt”. FIG. 6 is a diagram illustrating an example data structure of the first information.

In the example illustrated in FIG. 6, the first information is “shirt and blouse” (not illustrated). Moreover, the second information indicates the collar shapes of shirts and blouses. Furthermore, the third identification information indicates the sleeve lengths of shirts and blouses. In the first information illustrated in FIG. 6 too, in an identical manner to the explanation given above, the identification information and mask images 50B, which correspond to the categories identified by the identification information, are associated in advance.

Meanwhile, examples of the categories identified by the identification information can also include outerwear, pants, and skirts that come under apparel.

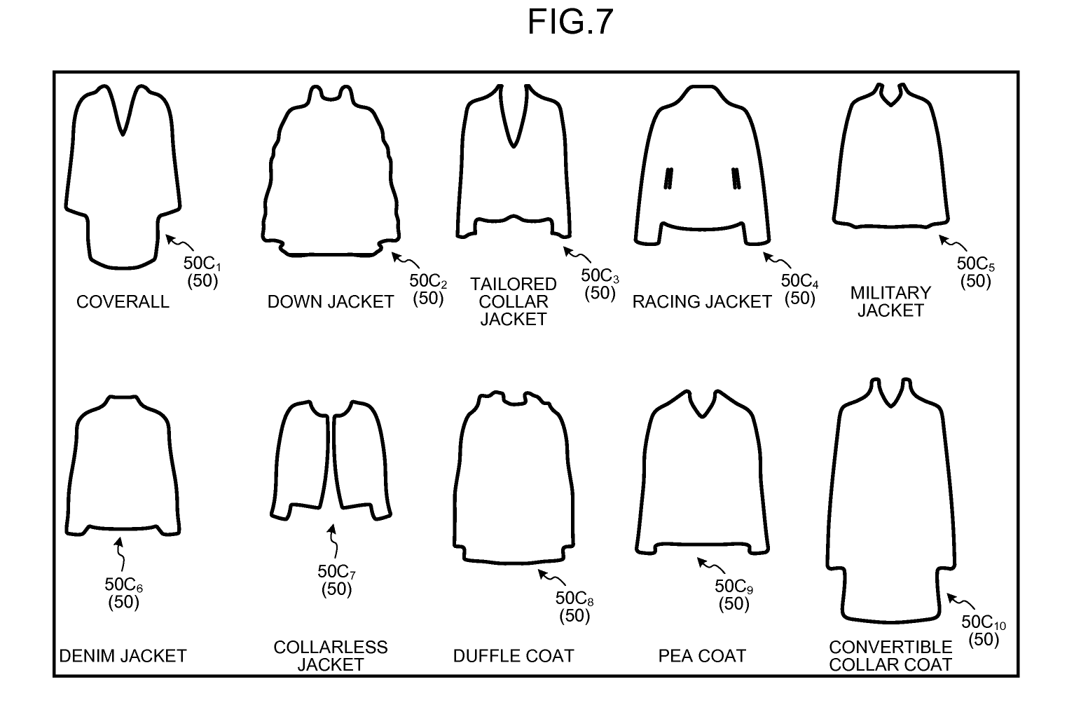

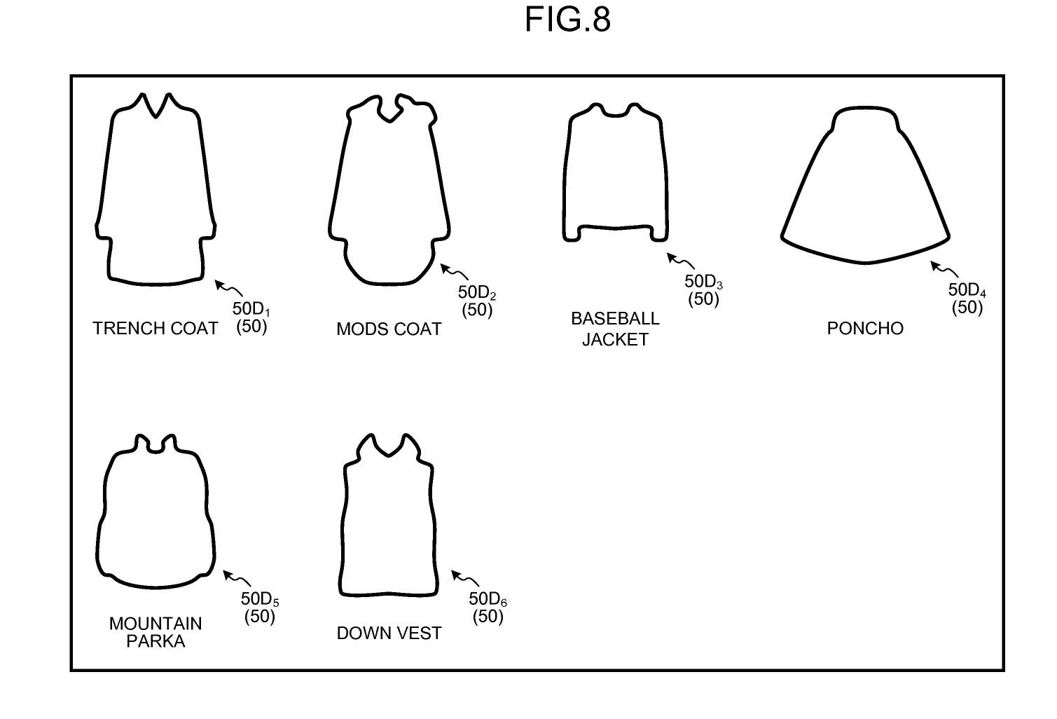

FIGS. 7 and 8 are diagrams illustrating other examples of the mask images 50.

As illustrated in FIGS. 7 and 8, the first information can be configured in such a way that “outerwear” is also treated as the identification information. In this case, the mask images 50 representing the contour shapes of the apparel (items) known as outerwear, such as overalls and a down jacket, are associated in advance (in FIG. 7, mask images 50C₁ to 50C₁₀; in FIG. 8, mask images 50D₁ to 50D₆) as the mask images 50 corresponding to the categories identified by the identification information.

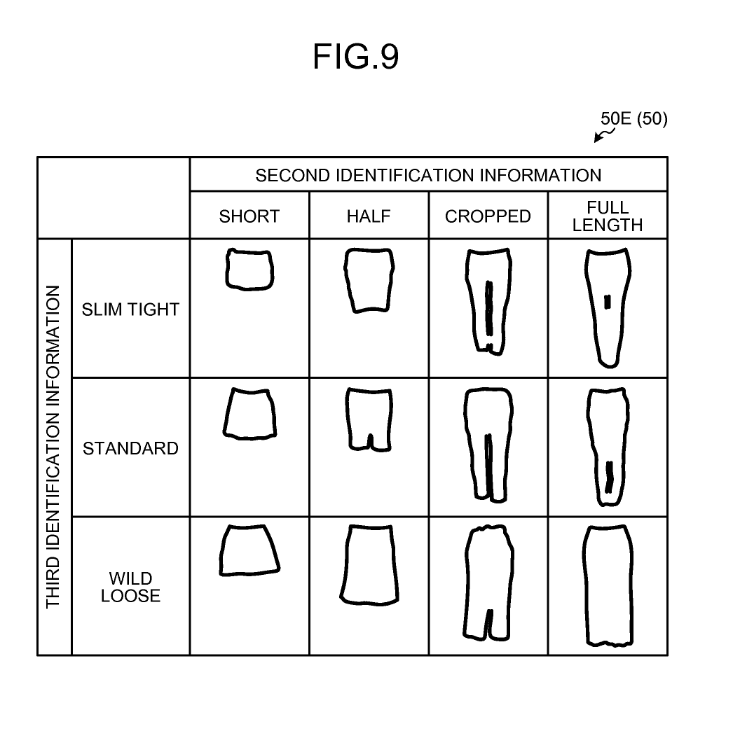

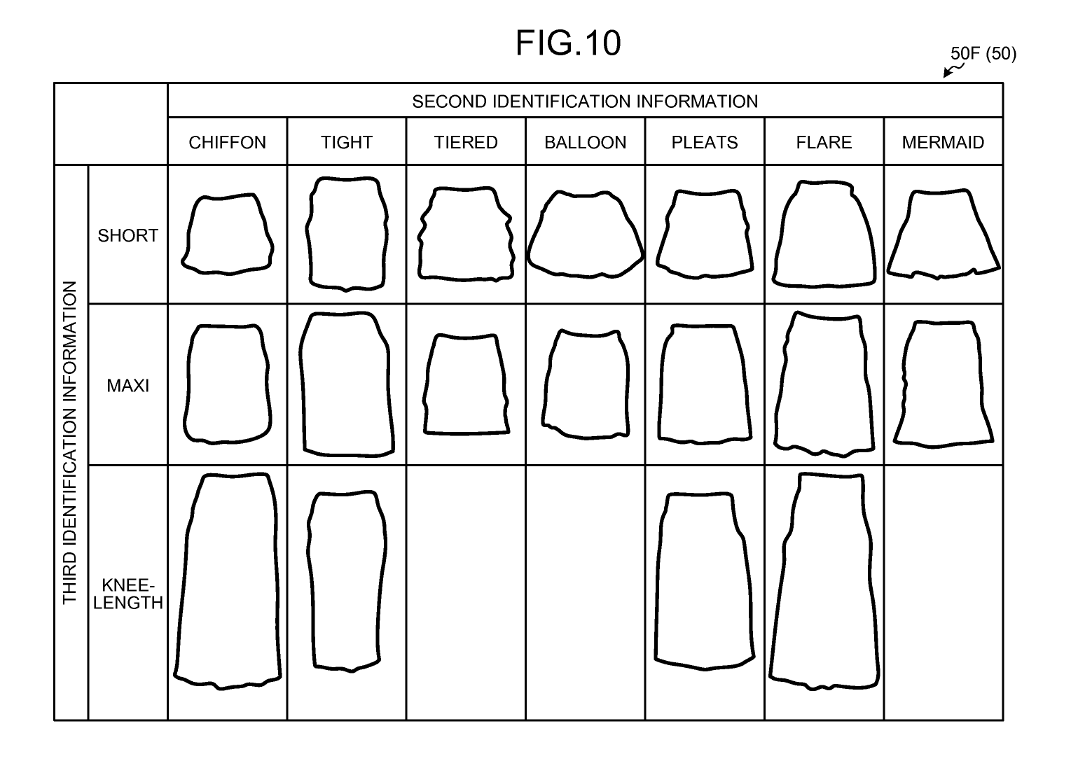

FIGS. 9 and 10 are diagrams illustrating exemplary data structures of the first information.

In the example illustrated in FIG. 9, the first identification information is “pants” (not illustrated). Moreover, the second information indicates the pants shapes. Furthermore, the third information indicates the pants lengths. In the first information illustrated in FIG. 9 too, in an identical manner to the explanation given above, the identification information (the first identification information, the second identification information, and the third identification information) and mask images 50E, which correspond to the categories identified by the identification information, are associated in advance.

In the example illustrated in FIG. 10, the first identification information is “skirt” (not illustrated). Moreover, the second identification information indicates the skirt shapes. Furthermore, the third identification information indicates the skirt lengths. In the first information illustrated in FIG. 10 too, in an identical manner to the explanation given above, the identification information (the first identification information, the second identification information, and the third identification information) and mask images 50F, which correspond to the categories identified by the identification information, are associated in advance.

Returning to the explanation with reference to FIG. 1, the display 18 displays various images (details given later) such as the mask images 50 stored in the memory 14, the first image obtained by the controller 12, and the second image retrieved by the controller 12. Herein, the display 18 is a known display device such as an LCD, a CRT, or a PDP.

The input device 16 is used by a user to perform various operation inputs. Examples of the input device 16 include a mouse, buttons, a remote controller, a keyboard, and a voice recognition device such as a microphone.

Meanwhile, the input device 16 and the display 18 can also be configured in an integrated manner. More particularly, the input device 16 and the display 18 can be configured as a user interface (UI) unit 17 having the input function and the display function. The UI unit 17 can be a touch screen LCD.

The controller 12 is a computer configured with a central processing unit (CPU), a read only memory (ROM), and a random access memory (RAM). The controller 12 performs the overall control of the retrieval apparatus 10. Meanwhile, the controller 12 can be configured using a circuit other than the CPU.

The controller 12 includes a second display controller 20, a receiving device 22, a modifying controller 24, an obtaining device 26, an extractor 28, a calculator 30, a determining controller 32, a first display controller 34, and an updating controller 36. Herein, some or all of the second display controller 20, the receiving device 22, the modifying controller 24, the obtaining device 26, the extractor 28, the calculator 30, the determining controller 32, the first display controller 34, and the updating controller 36 can be implemented by executing computer programs in a processor such as a CPU, that is, can be implemented using software; or can be implemented using hardware such as an integrated circuit; or can be implemented using a combination of software and hardware.

The obtaining device 26 obtains a first image. In the first embodiment, the obtaining device 26 obtains a first image from the image capturing unit 13. Alternatively, the obtaining device 26 can obtain a first image from an external device via a communicating unit (not illustrated). Still alternatively, the obtaining device 26 can read, from the memory 14, a first image that has been stored in advance.

The second display controller 20 performs control to display a selection screen on the display 18. Herein, the selection screen is a screen on which the user is allowed to select at least one of a plurality of mask images 50 that has been registered in advance in the first information.

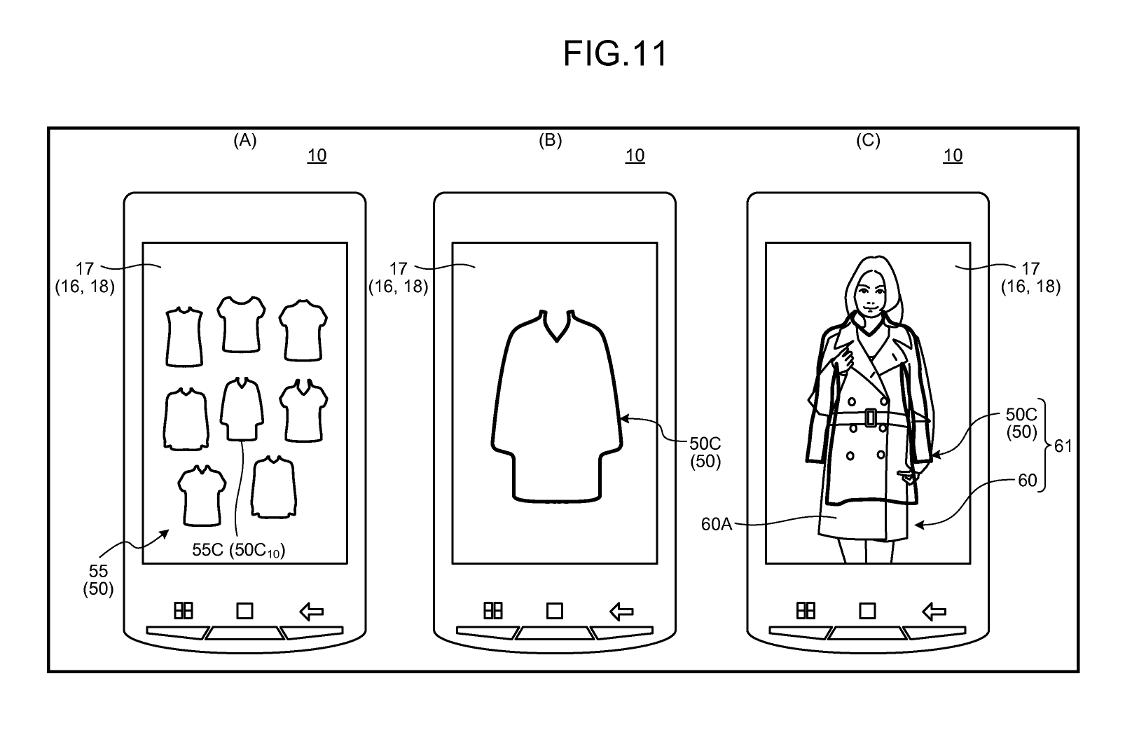

FIG. 11 is a schematic diagram illustrating exemplary images displayed on the display 18. Part (A) of FIG. 11 represents a diagram illustrating an example of a selection screen 55.

For example, the second display controller 20 reads all of the mask images 50 that are registered in the first information stored in the memory 14, and generates the selection screen 55 that includes a list of the mask images 50. Then, the second display controller 20 performs control to display the selection screen 55 on the display 18.

Alternatively, the second display controller 20 can generate the selection screen 55 that includes a list of the pieces of identification information registered in the first information, and perform control to display the selection screen 55 on the display 18. Meanwhile, the second display controller 20 creates in advance a tree structure in which the identification information registered in the first information is classified in a stepwise fashion from large classification to small classification. Then, the second display controller 20 can generate a selection screen including the identification information belonging to the large classification, and perform control to display the selection screen on the display 18. Subsequently, in response to a user instruction received from the input device 16, the selection screen 55 can be dynamically created in such a way that instructions from the user are received in a stepwise fashion from the large classification toward the small classification and eventually the identification information corresponding to a single mask image 50 is selected.

Moreover, for example, the second display controller 20 creates the selection screen 55 that includes information regarding a plurality of groups in which the pieces of identification information are classified in advance, and performs control to display the selection screen 55 on the display 18. Then, assume that one of the groups displayed in the selection screen 55 is selected by a user instruction received from the input device 16. At that time, the second display controller 20 performs control to display, on the display 18, the selection screen 55 that includes a list of the mask images 50 which correspond to the categories identified by the identification information belonging to the selected group (see part (A) of FIG. 11).

Returning to the explanation with reference to FIG. 1, the second display controller 20 performs control to display, on the display 18, the selected mask image 50, or a post-modification mask image 50 (details given later), or a superposed image (details given later).

The receiving device 22 receives various instructions from the input device 16. Upon being operated by the user, the input device 16 outputs an instruction according to the user operation to the controller 12. The receiving device 22 receives that instruction from the input device 16.

The receiving device 22 includes a first receiving device 22A, a second receiving device 22B, and a third receiving device 22C.

The first receiving device 22A receives, from the input device 16, at least a single selection from a plurality of mask images 50 stored in the memory 14. In the first embodiment, the first receiving device 22A receives the selection of a single mask image 50.

When the second display controller 20 performs control to display the selection screen on the display 18, the user operates the input device 16 while checking the selection screen and selects a single mask image 50. Then, the input device 16 outputs, to the controller 12, an instruction indicating the selected mask image 50. The first receiving device 22A receives, from the input device 16, an instruction indicating the selected mask image 50. In this way, the first receiving device 22A receives the selection of the mask image 50.

Part (B) of FIG. 11 represents a diagram illustrating an example of the selected mask image 50. The second display controller 20 performs control to display the selected mask image 50 (in part (B) of FIG. 11, the mask image 50C) on the display 18.

The superimposed image is an image formed by superimposing the selected mask image 50, which is received by the first receiving device 22A, on the first image obtained by the obtaining device 26.

Part (c) of FIG. 11 represents a diagram illustrating an exemplary superimposed image 61. In the state in which the selected mask image 50 is displayed on the display 18, the user takes a picture of a photographic subject wearing a coat 60A using the image capturing unit 13. As a result, the obtaining device 26 obtains a first image 60. Then, the second display controller 20 performs control to display, on the display 18, the superimposed image 61 formed by superimposing the selected mask image 50C on the first image 60 obtained by the obtaining device 26.

Returning to the explanation with reference to FIG. 1, the second receiving device 22B receives a modification instruction to modify the selected mask image 50. Herein, the modification instruction includes modification information, which indicates at least one of the amount of change in size of the selected mask image 50, the amount of enlargement or reduction of the selected mask image 50, and the direction and amount of rotation of the selected mask image 50. The amount of change in size of the selected mask image 50 is expressed using, for example, the aspect ratio of the mask image 50.

The direction of rotation of the mask image 50 is, for example, expressed as follows. For example, when the item belonging to the category corresponding to the mask image 50 is placed in the normal state, the direction of the item coincident with the direction of gravitational force is treated as the X-axis direction. Moreover, the direction of the item coincident with the horizontal direction is treated as the Y-axis direction. Then, the direction of rotation of the mask image 50 is expressed using the direction and amount of rotation around the X-axis and using the direction and amount of rotation around the Y-axis.

The modifying controller 24 modifies the selected mask image 50 according to the modification information included in the modification instruction.

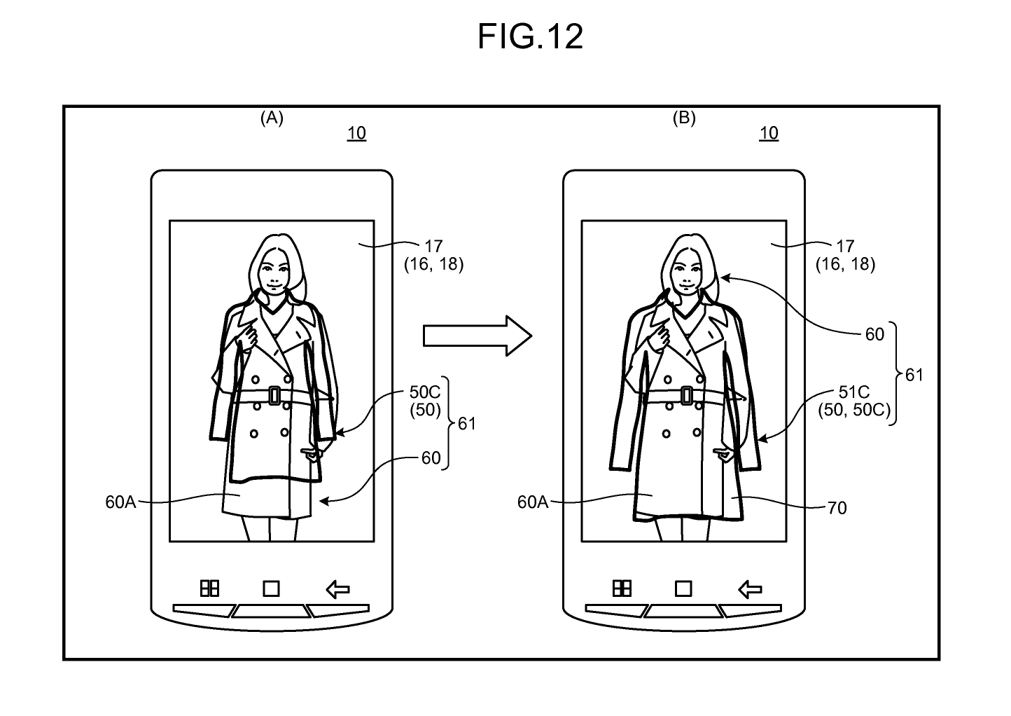

FIG. 12 is an explanatory diagram of a modification of the mask image 50.

When the mask image 50 is selected, the second display controller 20 performs control to display the superimposed image 61 on the display 18. Part (A) of FIG. 12 represents an explanatory diagram of the superimposed image 61. As illustrated in part (A) of FIG. 12, there are cases in which the contour shape of the coat 60A, which is the retrieval target area included in the first image 60, does not match with the contour shape of the selected mask image 50C. In that case, the user operates the input device 16 while checking the superimposed image 61 displayed on the display 18, and instructs modification in the shape of the hemline or the sleeve in the mask image 50C or instructs modification in the aspect ratio of the mask image 50. Then, the input device 16 outputs, to the controller 12, modification information according to the user operation. The second receiving device 22B receives the modification information. Subsequently, the modifying controller 24 modifies the mask image 50C in such a way that the shape of the mask image 50C matches with the shape specified in the modification information that is received by the second receiving device 22B.

The second display controller 20 creates the superimposed image 61 in which a mask image 51C, which is formed after the modification performed by the modifying controller 24, is superimposed on the first image 60; and performs control to display the superimposed image 61 on the display 18.

Part (B) of FIG. 12 represents a diagram illustrating an example of the post-modification mask image 51C. The mask image 50, which has the shape not matching with the contour shape of the coat 60A that is the retrieval target area included in the first image 60 (see part (A) of FIG. 12), is modified into the mask image 51C having the shape along the contour shape of the coat 60A (see part (B) of FIG. 12).

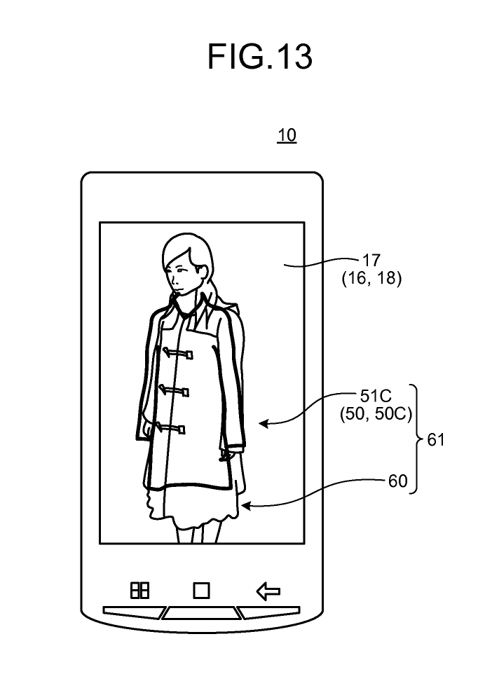

FIG. 13 is an explanatory diagram of rotational modification of the mask image 50.

Herein, it is assumed that the modification instruction includes modification information indicating the direction and amount of rotation of the mask image 50.

As illustrated in FIG. 13, assume that the person who is the photographic subject in the first image 60 is captured from a different direction than the image capturing direction corresponding to the mask image 50C. In that case, the user operates the input device 16 while checking the superimposed image 61 displayed on the display 18, and rotates the mask image 50C in a predetermined direction. At that time, the axis of rotation, the direction of rotation, and the amount of rotation can be specified. As a result, the input device 16 outputs, to the controller 12, modification information indicating the axis of rotation, the direction of rotation, and the amount of rotation according to the user operation.

The second receiving device 22B receives the modification information. Then, the modifying controller 24 rotates the mask image 50C so that the mask image 50C has the shape specified in the modification information received by the second receiving device 22B. That is, the modifying controller 24 modifies the mask image 50C.

The second display controller 20 creates the superimposed image 61 in which the mask image 51C, which is formed after the modification performed by the modifying controller 24, is superimposed on the first image 60; and performs control to display the superimposed image 61 on the display 18.

The mask image 50C, which did not match with the image capturing direction of the coat treated as the retrieval target area 60A included in the first image 60, is rotated and modified into the mask image 51C having the matching shape with the contour of the coat as illustrated in FIG. 13.

Returning to the explanation with reference to FIG. 1, the third receiving device 22C receives a search start instruction, which is a signal for instructing the start of a search for items. The user operates the input device 16 and issues a search start instruction. Then, the input device 16 outputs the search start instruction to the controller 12. Moreover, the third receiving device 22C receives that search start instruction from the input device 16.

The extractor 28 extracts an extraction area defined by the selected mask image 50 in the first image 60 obtained by the obtaining device 26.

More particularly, when the third receiving device 22C receives a search start instruction, the extractor 28 reads the first image 60 and the mask image 50 that are present in the superimposed image 61 being displayed on the display 18. Herein, the mask image 50 has been selected by the user. Then, the extractor 28 extracts the extraction area defined by the mask image 50 in the first image 60.

As described above, in the first embodiment, the mask image 50 is a linear image representing a contour. For that reason, in the first embodiment, the extractor 28 extracts, as the extraction area, the portion in the first image 60 that is enclosed by the mask image 50.

For example, assume that the third receiving device 22C receives a search start instruction when the superimposed image 61 illustrated in part (A) of FIG. 12 is displayed. In that case, the extractor 28 extracts, as an extraction area 70, the portion enclosed by the mask image 50C in the first image 60 included in the superimposed image 61.

For example, assume that the third receiving device 22C receives a search start instruction when the superimposed image 61 illustrated in part (B) of FIG. 12 is displayed. In that case, the extractor 28 extracts, as the extraction area 70, the portion enclosed by the post-modification mask image 51C in the first image 60 included in the superimposed image 61.

Returning to the explanation with reference to FIG. 1, the calculator 30 calculates a first feature quantity of the extraction area 70.

The first feature quantity represents a numerical value indicating the feature of the extraction area 70. Herein, the first feature quantity is a numerical value obtained by analyzing the extraction area 70.

For example, the calculator 30 calculates, as the first feature quantity, a value obtained by quantifying the contour shape of the extraction area 70. That is, the calculator 30 calculates, as the first feature quantity, the HoG feature quantity of the extraction area 70, or the SIFT feature quantity of the extraction area 70, or a combination of the HoG feature quantity and the SIFT feature quantity. Meanwhile, the color feature (i.e., pixel values of R, G, and B) of the extraction area 70 can also be added to the first feature quantity.

The calculator 30 calculates the first feature quantity by applying the same rule as the rule applied for the second feature quantity. For example, assume that the second feature quantity is a value obtained when the contour shape of the item indicated by the second image is quantified using the SIFT feature quantity. In that case, the calculator 30 quantifies the contour shape of the extraction area 70 using the SIFT feature quantity. Then, the calculator 30 outputs the quantified value as the first feature quantity.

The determining controller 32 searches the memory 14 for the pieces of second information. Then, the determining controller 32 determines a second image corresponding to the second feature quantity that has the degree of similarity with the first feature quantity, which is calculated by the calculator 30, equal to or greater than a threshold value.

More specifically, firstly, the determining controller 32 calculates the degree of similarity between the first-feature quantity, which is calculated by the calculator 30, with a plurality of second feature quantities corresponding to a plurality of second images registered in the second information. For example, assume that the degree of similarity is “1” when two feature quantities are identical, and the degree of similarity is “0” when two feature quantities are different by a value equal to or greater than a predetermined value. Then, the determining controller 32 calculates the degrees of similarity in such a way that, closer the value of a feature quantity, greater is the degree of similarity approaching “1” from “0”.

More particularly, the determining controller 32 calculates the degrees of similarity using the sum of squared difference (SSD), or using the sum of absolute difference (SAD), or using the normalized cross-correlation.

Then, of a plurality of second images registered in the second information, the determining controller 32 searches for the second image having the degree of similarity with the first feature quantity equal to or greater than a threshold value. Then, the determining controller 32 determines the retrieved second image to be the target second image for display.

If a plurality of second images is found to have the degree of similarity with the first feature quantity equal to or greater than the threshold value, then the determining controller 32 determines the second image having the highest degree of similarity to be the target second image for display. Alternatively, if a plurality of second images is found to have the degree of similarity with the first feature quantity equal to or greater than the threshold value, then the determining controller 32 can determine all such second images to be the target second images for display.

The threshold value used by the determining controller 32 can be set in advance to an arbitrary value. Moreover, the determining controller 32 can store that threshold value in advance.

The first display controller 34 performs control to display, on the display 18, the second image determined by the determining controller 32.

Meanwhile, there is no restriction on the display format of the second images. For example, if the determining controller 32 determines a plurality of second images, then the first display controller 34 performs control to display a list of a plurality of second images on the display 18. Herein, for example, the first display controller 34 displays a plurality of second images in a tiled format on the display 18. Alternatively, the first display controller 34 can display a plurality of second images in any known format such as flip switch, cover switch, ring switch, or grouping. Moreover, when the user operates the input device 16 and issues an instruction to select a single second image from among a plurality of second images displayed on the display 18, the first display controller 34 can perform control to display the selected second image in an enlarged manner.

The updating controller 36 updates the memory 14.

For example, assume that an instruction to update the second images in the memory 14 is issued using the input device 16, and that the receiving device 22 receives a second image and a second feature quantity from an external device via an I/F (not illustrated). At that time, the updating controller 36 registers the received second image and the received second feature quantity in the second information, and updates the second information in the memory 14.

Alternatively, assume that the receiving device 22 receives a second image from an external device via an I/F (not illustrated). At that time, the updating controller 36 registers the received second image in the second information, and updates the second information in the memory 14. In that case, the controller 12 calculates the second feature quantity corresponding to the second image by implementing the method described above, associates the second feature quantity to the second image, and updates the second information.

Still alternatively, the receiving device 22 receives contents data via an I/F (not illustrated) and a communication line (not illustrated). In that case, the receiving device 22 can be configured to further include functions such as a television tuner, which receives airwaves from a broadcast station (not illustrated) as contents data, or a network interface, which receives contents data from the Internet.

The contents data contains programs, and contains metadata indicating the contents of the programs. Examples of the programs include television (TV) broadcast programs; movies/video clips that are streamed, sold, and delivered in memory mediums such as digital versatile disks (DVDs) or as part of the video on demand (VOD) service; dynamic picture images streamed on the world wide web (WEB); dynamic picture images captured in cameras or cellular phones; and recorded programs that are recorded in video recorders, HDD recorders, DVD recorders, and TVs or personal computers (PCs) equipped with the video recording function.

The metadata indicates the contents of the programs. In the first embodiment, the metadata at least contains information indicating the second information included in the image at each position (frame) during a program.

In this case, the updating controller 36 updates the second images from the contents data. Then, the updating controller 36 registers the extracted second images in the second information and updates the second information in the memory 14. In that case, the controller 12 calculates the second feature quantities corresponding to the second images by implementing the method described above, associates the second feature quantities to the second images, and updates the second information.

In an identical manner, an instruction to update the first information in the memory 14 is issued using the input device 16, and the receiving device 22 receives a mask image and identification information from the input device 16 or from an external device. Then, the updating controller 36 registers the received identification information and the received mask image in a corresponding manner in the first information, and updates the first information in the memory 14.

Given below is the explanation of a retrieval operation performed in the retrieval apparatus 10.

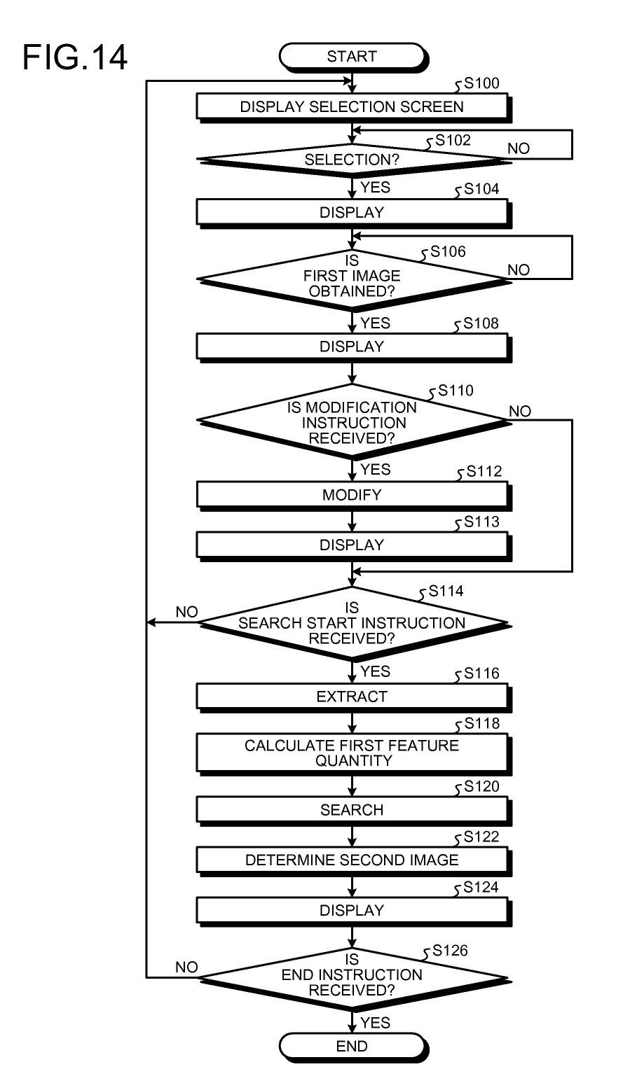

FIG. 14 is a flowchart for explaining a sequence of operations during the retrieval operation performed in the retrieval apparatus 10 according to the first embodiment.

Firstly, the second display controller 20 performs control to display the selection screen 55 of the mask images 50 on the display 18 (Step S100).

As a result of performing the operation at Step S100, the selection screen 55 of the mask image 50 is displayed on the display 18 (see part (A) of FIG. 11).

Then, the first receiving device 22A determines whether or not a single mask image 50 has been selected (Step S102). Herein, the first receiving device 22A performs the determination at Step S102 by determining whether or not a signal indicating the user-selected mask image 50 is received from the input device 16.

Until a single mask image is determined to have been selected at Step S102 (Yes at Step S102), the first receiving device 22A repeatedly determines that no mask image is selected (No at Step S102). When a single mask image is determined to have been selected at Step S102 (Yes at Step S102), the system control proceeds to Step S104.

Then, the second display controller 20 performs control to display the mask image 50, which is selected at Step S102, on the display 18 (Step S104).

As a result of performing the operation at Step S104, the selected mask image 50 is displayed on the display 18 (see part (B) of FIG. 11).

Subsequently, the obtaining device 26 determines whether or not the first image 60 is obtained (Step S106). The obtaining device 26 performs the determination at Step S106 by determining whether or not the first image 60 is obtained from the image capturing unit 13. Until the first image 60 is obtained at Step S106 (Yes at Step S106), the obtaining device 26 repeatedly determines that the first image 60 is not obtained (No at Step S106). When the first image 60 is obtained (Yes at Step S106), the system control proceeds to Step S108.

The second display controller 20 performs control to display, on the display 18, the superimposed image 61 formed by superimposing the mask image 50, which is selected at Step S102, on the first image 60 obtained at Step S106 (Step S108).

As a result of performing the operation at Step S108, the superimposed image 61 is displayed on the display 18 (see part (C) of FIG. 11).

Then, the second receiving device 22B determines whether or not a modification instruction is received with respect to the mask image 50 selected at Step S102 (Step S110). The second receiving device 22B performs the determination at Step S110 by determining whether or not a modification instruction is received from the input device 16.

If a modification instruction is determined not to have been received at Step S110 (No at Step S110), the system control proceeds to Step S114 (described later). On the other hand, when a modification instruction is determined to have received (Yes at Step S110), the system control proceeds to Step S112. Then, according to the modification information included in the modification instruction, the modifying controller 24 modifies the mask image 50 selected at Step S102 (Step S112).

The second display controller 20 performs control to display the superimposed image 61 on the display 18 (Step S113). This superimposed image 61 is formed by superimposing the mask image 50, which is selected at Step S102 and which is modified at Step S112, on the first image 60 obtained at Step S106.

As a result of performing the operation at Step S113, the superimposed image 61, which is formed by superimposing the post-modification mask image 50 (i.e., the mask image 51C) on the first image 60, is displayed on the display 18 (see part (B) in FIG. 12).

Subsequently, the third receiving device 22C determines whether or not a search start instruction is received (Step S114). Herein, the third receiving device 22C performs the determination at Step S114 by determining whether or not a search start instruction is received from the input device 16.

If it is determined that no search start instruction is received (No at Step S114), then the system control returns to Step S100 described above. On the other hand, if it is determined that a search start instruction is received (Yes at Step S114), then the system control proceeds to Step S116.

Then, the extractor 28 extracts, from the first image 60, the extraction area 70 defined by the selected mask image 50 (Step S116). If a modification instruction has been received at Step S110, then the extractor 28 extracts, from the first image 60, the extraction area 70 defined by the mask image 50 that has been selected and modified.

Thus, during the determination performed at Step S114, consider a case in which the superimposed image 61 displayed on the display 18 is the superimposed image 61 illustrated in part (A) of FIG. 12. In that case, the extractor 28 extracts, from the first image 60 illustrated in part (A) of FIG. 12, the extraction area 70 defined by the mask image 50C.

Alternatively, during the determination performed at Step S114, consider a case in which the superimposed image 61 displayed on the display 18 is the superimposed image 61 including the modified mask image 50 (see part (B) of FIG. 12). In that case, the extractor 28 extracts, from the first image 60 illustrated in part (B) of FIG. 12, the extraction area 70 defined by the post-modification mask image 51C.

Subsequently, the calculator 30 calculates the first feature quantity of the extraction area 70 that is extracted at Step S116 (Step S118).

Meanwhile, consider a case in which the extraction area 70 extracted at Step S116 is defined by the mask image 50 that has been rotated according to a modification instruction. In that case, the calculator 30 calculates the first feature quantity after modifying the extraction area 70, which is extracted at Step S116, to the state prior to the rotation according to the modification instruction.

As a result of this operation, even if an item included in the first image is captured from a different angle than the second image registered in the second information, it becomes possible to calculate the degree of similarity (described later) with accuracy.

Subsequently, the determining controller 32 searches the memory 14 for the second information (Step S120). Herein, at Step S120, the determining controller 32 calculates the degree of similarity between the first feature quantity calculated at Step S118 and the second feature quantity corresponding to each of a plurality of second images registered in the second information. Then, of a plurality of second images registered in the second information, the determining controller 32 searches for a second image having the degree of similarity with the first feature quantity equal to or greater than a threshold value.

That is, the determining controller 32 searches for the second image using the extraction area defined by the mask image 50 selected at Step S102 in the first image 60, as the retrieval target area.

Then, the determining controller 32 determines the second image retrieved at Step S120 as the target second image for display (Step S122).

Subsequently, the first display controller 34 performs control to display, on the display 18, the second image determined at Step S122 (Step S124).

As a result of performing the operation at Step S124, the second image of the item related to the extraction area, which is defined by the mask image 50 selected at Step S102 in the first image 60, is displayed as the search result on the display 18.

Subsequently, the receiving device 22 determines whether or not an end instruction for ending operations is received from the input device 16 (Step S126). If the receiving device 22 receives an operation continuation instruction or an instruction to display another second image from the input device 16 (No at Step S126), then the system control returns to Step S100. However, when the receiving device 22 receives an end instruction (Yes at Step S126), it marks the end of the routine.

As explained above, in the retrieval apparatus 10 according to the first embodiment, the first receiving device 22A receives the selection of at least one mask image 50 from among a plurality of predetermined mask images 50 indicating retrieval target areas. The obtaining device 26 obtains the first image 60. The calculator 30 calculates the first feature quantity of the extraction area 70 defined by the selected mask image 50 in the first image 60. The determining controller 32 searches for the second information in which the second image and the second feature quantity of each of a plurality of items are associated with each other; and determines the second image corresponding to the second feature quantity that has the degree of similarity with the first feature quantity equal to or greater than a threshold value. The first display controller 34 performs control to display the determined second image on the display 18.

In this way, in the retrieval apparatus 10 according to the first embodiment, a plurality of mask images 50, which indicate the retrieval target areas, are provided in advance. Then, the selection of at least one mask image 50 from among a plurality of mask images 50 is received from the user. In the retrieval apparatus 10, the extraction area defined by the selected mask area 50 in the first image is used as a search key in searching for the second information; and the second image similar to the extraction area is determined.

For that reason, even if at least a portion of the retrieval target item in the first image is positioned on the back of some other item, it becomes possible to accurately define the area of the retrieval target item.

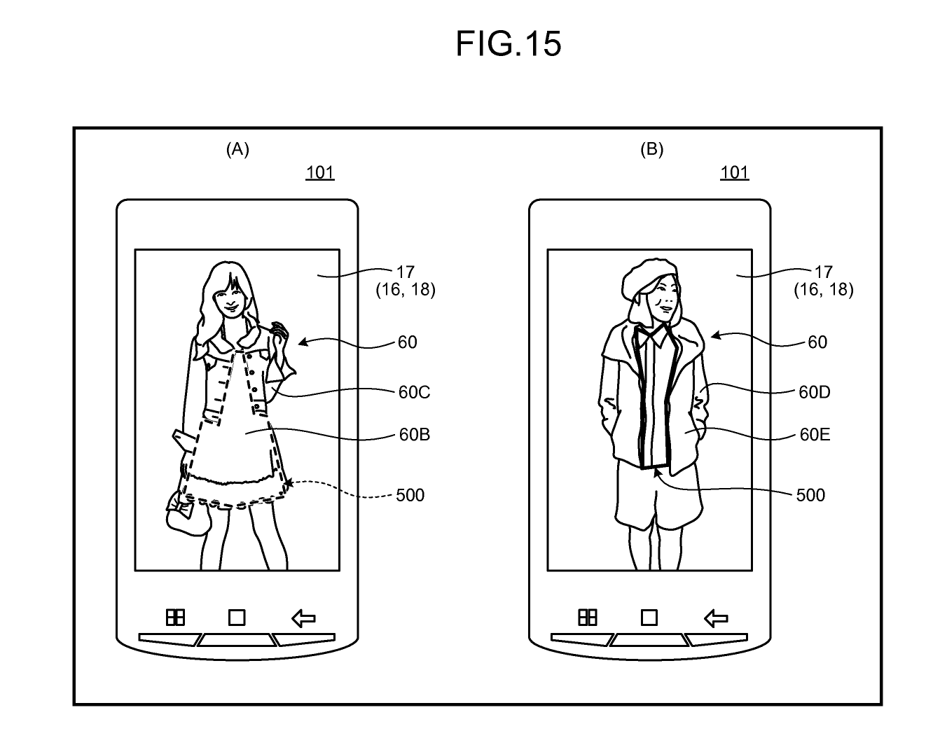

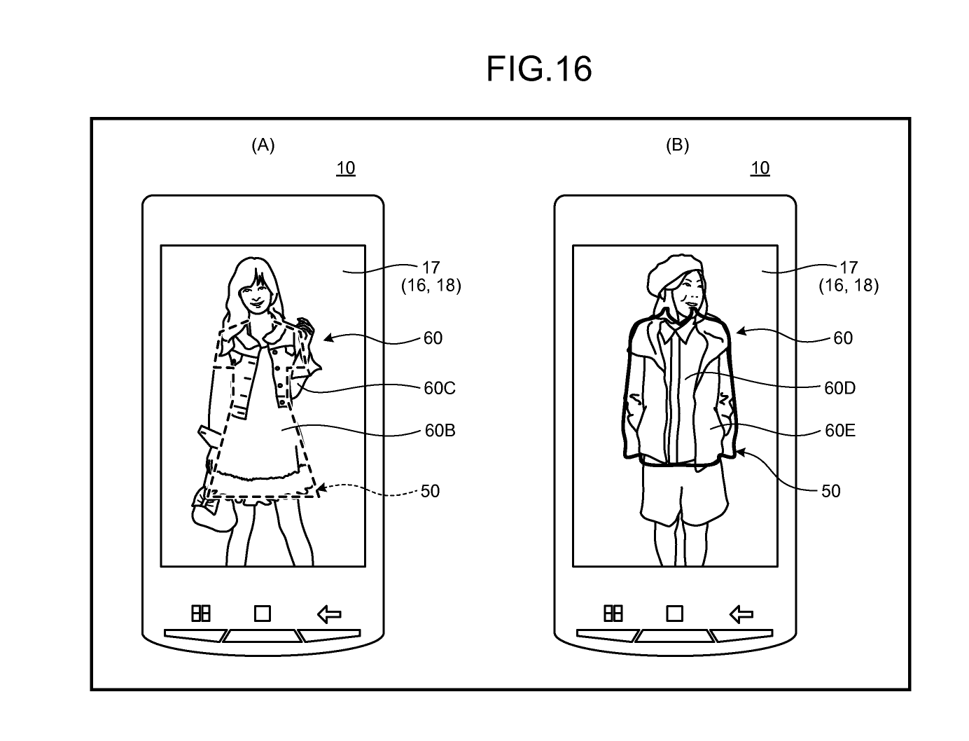

FIG. 15 is an explanatory diagram about defining the retrieval target area in a conventional retrieval apparatus 101. FIG. 16 is an explanatory diagram about defining the retrieval target area in the retrieval apparatus 10 according to the first embodiment.

For example, assume that the first image 60 includes a plurality of items. Moreover, assume that one of the items, which represent retrieval target areas, is positioned on the back of some other item.

In the examples illustrated in part (A) of FIG. 15 and part (A) of FIG. 16, the first image 60 includes a plurality of items, namely, a one-piece suit 60B and a jacket 60C. Herein, the photographic subject is wearing the jacket 60C on top of the one-piece suit 60B.

In the case of specifying the one-piece suit 60B as the retrieval target area (see part (A) of FIG. 15 and par (A) of FIG. 16), some portion of the one-piece suit 60B is hiding behind the jacket 60C.

In that regard, in the conventional retrieval apparatus 101, if the one-piece suit 60B is specified as the retrieval target area; as illustrated in part (A) of FIG. 15, only an area 500 of the one-piece suit 60B that is exposed from the jacket 60C is specified. This area 500 has a different shape than the one-piece suit 60B that is the retrieval target area. Hence, in the conventional retrieval apparatus 101, it is not possible to accurately specify the area of the retrieval target item.

In contrast, in the retrieval apparatus 10 according to the first embodiment, if the one-piece suit 60B is specified as the retrieval target area; as illustrated in part (A) of FIG. 16, the user selects, from among a plurality of mask images 50, the mask image 50 that is closest to the shape of the one-piece suit 60B. As a result, in the retrieval apparatus 10, even if some portion of the one-piece suit 60B is positioned on the back of some other item (herein, the jacket 60C), the mask image 50 formed according to the shape of the one-piece suit 60B is selected. Thus, in the retrieval apparatus 10 according to the first embodiment, the area of the retrieval target item can be virtually captured, and the distinguishing area can be specified with accuracy.

In the examples illustrated in part (B) of FIG. 15 and part (B) of FIG. 16, the first image 60 includes a plurality of items, namely, a shirt 60D and a cardigan 60E. Herein, the photographic subject is wearing the cardigan 60E on top of the shirt 60D.

In the case of specifying the shirt 60D as the retrieval target area (see part (B) of FIG. 15 and part (B) of FIG. 16), some portion of the shirt 60D is hiding behind the cardigan 60E.

In that regard, in the conventional retrieval apparatus 101, if the shirt 60D is specified as the retrieval target area; as illustrated in part (B) of FIG. 15, only the area 500 of the shirt 60D that is exposed from the cardigan 60E is specified. This area 500 has a different shape than the shirt 60D that is the retrieval target area. Hence, in the conventional retrieval apparatus 101, it is not possible to accurately specify the area of the retrieval target item.

In contrast, in the retrieval apparatus 10 according to the first embodiment, if the shirt 60D is specified as the retrieval target area; as illustrated in part (B) of FIG. 16, the user selects, from among a plurality of mask images 50, the mask image 50 that is closest to the shape of the shirt 60D. As a result, in the retrieval apparatus 10, even if some portion of the shirt 60D is positioned on the back of some other item (herein, the cardigan 60E), the mask image 50 according to the shape of the shirt 60D is selected. Thus, in the retrieval apparatus 10 according to the first embodiment, the area of the retrieval target item can be virtually captured, and the distinguishing area can be specified with accuracy.

Then, in the first embodiment, using the extraction area 70 defined by the selected mask image 50 in the first image, the second image of the related item is retrieved.

Thus, in the retrieval apparatus 10 according to the first embodiment, the item related to the search target can be retrieved with accuracy.

Meanwhile, as described above, the items to be searched for by the retrieval apparatus 10 are not limited to clothing. That is, for example, if components are used the items, the items related to a component that is positioned on the back of some other component can be retrieved with accuracy. Therefore, the retrieval apparatus 10 according to the first embodiment can be implemented in various inspection systems.

Moreover, in the first embodiment, the explanation is given for a case in which the obtaining device 26 obtains a first image from the image capturing unit 13. However, the obtaining device 26 is not limited to obtain a first image from the image capturing unit 13.

Alternatively, for example, the obtaining device 26 can obtain a first image from an external device via an interface (I/F) (not illustrated) or a communication line such as the Internet. Examples of the external device include a PC or a WEB server of known types. Still alternatively, the obtaining device 26 can store a first image in advance in the memory 14 or a RAM (not illustrated), and obtain the first image from the memory 14 or the RAM.

Still alternatively, the obtaining device 26 can obtain the first image in the following manner. More specifically, the obtaining device 26 is configured to further include functions such as a television tuner, which receives airwaves from a broadcast station (not illustrated) as contents data, or a network interface, which receives contents data from the Internet. Regarding the contents data, the explanation is given earlier. Hence, that explanation is not repeated herein.

Then, the controller 12 displays, on the display 18, the programs included in the contents data. Subsequently, the user operates the input device 16 and issues an instruction to import an image. That is, the user operates the input device 16 while checking the programs displayed on the display 18, and can input an instruction to import an image from the programs displayed on the display 18.

Upon receiving an image import instruction from the input device 16, the obtaining device 26 can obtain, as the first image, a frame image (also called a frame) that is being displayed on the display 18 at the time of reception of the image import instruction. Alternatively, the obtaining device 26 can import, as the first image, a frame image that was displayed before (for example, a few seconds before) the frame image that is being displayed on the display 18 at the time of reception of the image import instruction.

Meanwhile, in the first embodiment, the explanation is given for a case in which the first display controller 34 displays, on the display 18, the second image that is retrieved by the determining controller 32. However, alternatively, the first display controller 34 can display, on the display 18, a synthetic image formed by synthesizing the second image, which is retrieved by the determining controller 32, on the first image.

Herein, the synthetic image can be generated by implementing a known method. For example, the method disclosed in JP-A 2011-48461 (KOKAI) or in JP-A 2006-249618 (KOKAI) can be used in generating the synthetic image.

### Second Embodiment

In the first embodiment, the explanation is given for an example in which the memory 14 is installed in the retrieval apparatus 10. In a second embodiment, the explanation is given for a case in which the memory 14 is installed in a memory device that is connected to the retrieval apparatus 10 via a communication line.

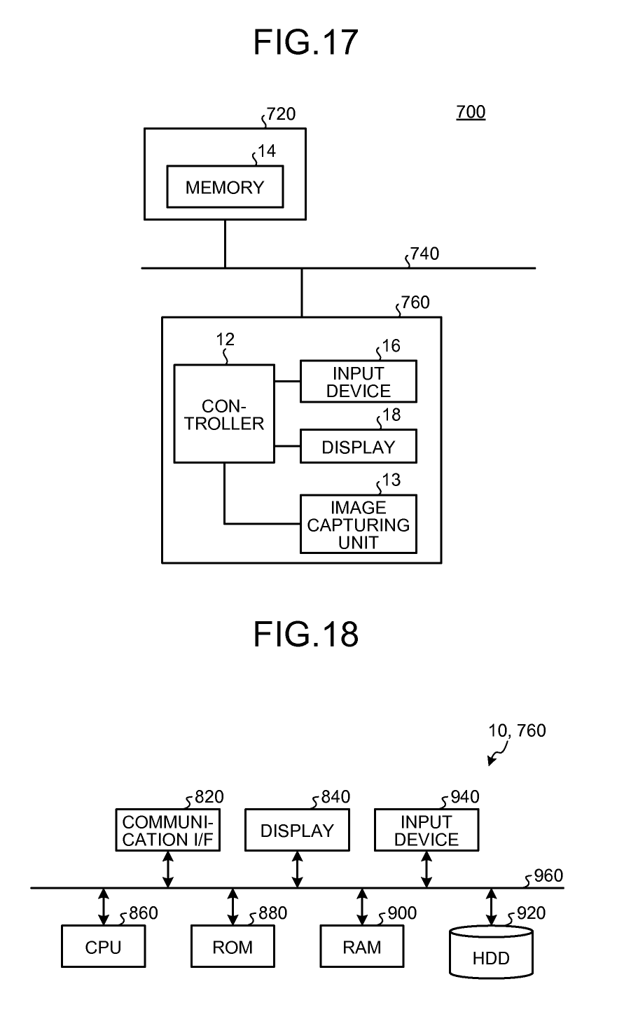

FIG. 17 is a schematic diagram illustrating a retrieval system 700. In the retrieval system 700, a retrieval apparatus 760 and a memory device 720 are connected via a communication line 740.

The retrieval apparatus 760 includes the controller 12, the input device 16, the display 18, and the image capturing unit 13. Herein, the controller 12, the input device 16, the display 18, and the image capturing unit 13 are identical to the functional components of the retrieval apparatus 10 according to the first embodiment. Thus, except for the fact that the memory 14 is not installed, the retrieval apparatus 760 has an identical configuration to the retrieval apparatus 10 according to the first embodiment.

Thus, the functional components identical to the first embodiment are referred to by the same reference numerals, and the detailed explanation thereof is not repeated.

The communication line 740 is either a wired communication line or a wireless communication line. The memory device 720 includes the memory 14, and can be a PC of known type or any type of server. The memory 14 is identical to the memory 14 according to first embodiment.

As illustrated in FIG. 17, the memory 14 is separated from the retrieval apparatus 760, and is installed in the memory device 720 that is connected to the retrieval apparatus 760 via the communication line 740. With that, the same memory 14 becomes accessible to a plurality of retrieval apparatus 760, thereby enabling uniform management of the data stored in the memory 14.

Given below is the explanation of a hardware configuration of the retrieval apparatus 10 according to the first embodiment and the retrieval apparatus 760 according to the second embodiment. FIG. 18 is a block diagram illustrating an exemplary hardware configuration of the retrieval apparatus 10 according to the first embodiment and the retrieval apparatus 760 according to the second embodiment.

The retrieval apparatus 10 according to the first embodiment and the retrieval apparatus 760 according to the second embodiment have the hardware configuration of a general-purpose computer in which a communication I/F 820, a display 840, an input device 940, a CPU 860, a read only memory (ROM) 880, a random access memory (RAM) 900, and an HDD 920 are interconnected by a bus 960.

The CPU 860 is a processor that controls the operations of the retrieval apparatus 10 in entirety or the retrieval apparatus 760 in entirety. The RAM 900 is used to store data that is required in various operations performed by the CPU 860. The ROM 880 is used to store computer programs that are executed by the CPU 860 for performing various operations. The HDD 920 is used to store data stored in the memory 14. The communication I/F 820 is an interface that establishes connection with an external device or an external terminal via a communication line, and performs data communication with the external device or the external terminal. The display 840 is equivalent to the display 18. The input device 940 is equivalent to the input device 16.

The computer programs executed in the retrieval apparatus 10 according to the first embodiment and the retrieval apparatus 760 according to the second embodiment are stored in advance in the ROM 880.

Alternatively, the computer programs executed in the retrieval apparatus 10 according to the first embodiment and the retrieval apparatus 760 according to the second embodiment can be recorded as installable or executable files in a computer-readable recording medium such as a compact disk read only memory (CD-ROM), a flexible disk (FD), a compact disk recordable (CD-R), or a digital versatile disk (DVD).

Still alternatively, the computer programs executed in the retrieval apparatus 10 according to the first embodiment and the retrieval apparatus 760 according to the second embodiment can be saved as downloadable files on a computer connected to the Internet or can be made available for distribution through a network such as the Internet.

The computer program executed for performing a search operation in the retrieval apparatus 10 according to the first embodiment and the retrieval apparatus 760 according to the second embodiment contains modules for the constituent elements described above (the second display controller 20, the receiving device 22, the modifying controller 24, the obtaining device 26, the extractor 28, the calculator 30, the determining controller 32, the first display controller 34, and the updating controller 36). As the actual hardware, the CPU 860 reads the computer program for performing a search operation from a memory medium such as the ROM 880 and executes it so that each constituent element is loaded in a main memory device. As a result, each constituent element is generated in the main memory device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A retrieval apparatus comprising:
a first receiving device to receive at least one mask image from among a plurality of predetermined mask images indicating retrieval target areas;
an obtaining device to obtain a first image;
a calculator to calculate a first feature quantity of an extraction area, which of the first image is enclosed by the mask image;
a determining controller to search for second information, in which a second image and a second feature quantity of each of a plurality of items are associated with each other, and determine the second image corresponding to the second feature quantity having a degree of similarity with the first feature quantity equal to or greater than a threshold value; and
a first display controller to perform control to display the determined second image on a display.

2. The apparatus according to claim 1, further comprising:
a second receiving device to receive a modification instruction to modify the mask image; and
a modifying controller to, when the modification instruction is received, modify the mask image, wherein
the calculator calculates the first feature quantity of the extraction area defined by the post-modification mask image in the first image.

3. The apparatus according to claim 2, wherein
the modification instruction includes modification information which indicates at least one of an amount of modification in size of the mask image, an amount of enlargement or reduction of the selected mask image, and direction and amount of rotation of the mask image, and
the modifying controller modifies the mask image according to the modification information.

4. The apparatus according to claim 1, wherein the plurality of mask images have at least mutually different shapes or mutually different sizes.

5. The apparatus according to claim 1, wherein each of the mask images corresponds to one of a plurality of categories which are formed by classifying the plurality of items according to a predetermined classification condition.

6. The apparatus according to claim 5, wherein the mask image is a linear image formed along at least a portion of a common contour of the item belonging to each of the plurality of categories.

7. The apparatus according to claim 1, further comprising a second display controller to perform control to display, on the display, a selection screen which enables a user to select at least one mask image from among the plurality of mask images, wherein
after the selection screen is displayed on the display, the first receiving device receives selection of the mask image.

8. The apparatus according to claim 7, wherein the selection screen includes at least either the plurality of mask images or identification information of the plurality of mask images.

9. A retrieval method comprising:
receiving selection of at least one mask image from among a plurality of predetermined mask images indicating retrieval target areas;
obtaining a first image;
calculating a first feature quantity of an extraction area defined by the mask image in the first image;
searching for second information, in which a second image and a second feature quantity of each of a plurality of items are associated with each other, and determining the second image corresponding to the second feature quantity having a degree of similarity with the first feature quantity equal to or greater than a threshold value; and
performing control to display the determined second image on a display.

10. A computer program product comprising a computer readable medium including programmed instructions, wherein the instructions, when executed by a computer, cause the computer to execute:
receiving selection of at least one mask image from among a plurality of predetermined mask images indicating retrieval target areas;
obtaining a first image;
calculating a first feature quantity of an extraction area defined by the mask image in the first image;
searching for second information, in which a second image and a second feature quantity of each of a plurality of items are associated with each other, and determining the second image corresponding to the second feature quantity having a degree of similarity with the first feature quantity equal to or greater than a threshold value; and
performing control to display the determined second image on a display.
